(19) United States
(12) Patent Application Publication
(10) Pub. No.: US 2023/0400043 A1
(43) Pub. Date: Dec. 14, 2023

(54) AIRFLOW CONTROL DEVICES AND RELATED METHODS

(71) Applicant: White Rhino U.S.A., LLC, Draper, UT (US)

(72) Inventor: Adnan Afridi, Herriman, UT (US)

(21) Appl. No.: 18/165,088

(22) Filed: Feb. 6, 2023

Related U.S. Application Data
(60) Provisional application No. 63/366,042, filed on Jun. 8, 2022.

(51) Int. Cl. F15D 1/00; A24F 3/00; A24F 5/00; B33Y 80/00

(52) U.S. Cl. CPC F15D 1/0015; A24F 3/00; A24F 5/00; B33Y 80/00

(57) ABSTRACT

An airflow control device may include a base portion and a cap portion. The base portion may define an internal cavity and channels configured to direct airflow alongside the base portion. The cap portion may be configured to removably connect to the base portion to fully enclose the internal cavity. Additional devices, systems including the devices, and methods of manufacturing the devices are also disclosed.

### CROSS-REFERENCE TO RELATED APPLICATION

This application claims the benefit under 35 U.S.C. § 119(e) of U.S. Provisional Patent Application Ser. No. 63/366,042, filed Jun. 8, 2022, the disclosure of which is hereby incorporated herein in its entirety by this reference.

### TECHNICAL FIELD

The present disclosure relates generally to airflow control devices, and related systems and methods. More particularly, the present disclosure relates to airflow control devices as well as associated systems and methods for applications such as, for example, vaporizing and/or smoking.

### BRIEF SUMMARY

Various embodiments of the disclosure relate to airflow control devices that are generally used in the context of vaporizing and/or smoking. According to some embodiments, the airflow control device may include a base portion defining an internal cavity. The airflow control device may additionally include a cap portion configured to removably connect to the base portion to fully enclose the internal cavity. In additional embodiments, the base portion of the airflow control device may include one or more channel(s) through which airflow may be directed. The shape of the channel(s) may be tailored such that the airflow control device may move (e.g., rotationally) in response to movement of air through the channels of the base portion of the airflow control device.

According to some embodiments, a system includes a pipe and an airflow control device adjacent to the pipe. The pipe may include a first end comprising sidewalls defining a central cavity, and a second end opposite the first end. The airflow control device may be adjacent to the sidewalls of the first end of the pipe to restrict airflow into the first end of the pipe. The airflow control device may include a base portion defining an internal cavity. The base portion may additionally define channels configured to direct airflow from outside the first end of the pipe, along the channels, and inside of the first end of the pipe. The airflow control device may additionally include a cap portion configured to removably connect to the base portion to fully enclose the internal cavity.

### BRIEF DESCRIPTION OF THE DRAWINGS

FIG. 1 is a perspective view of an airflow control device in an assembled state, in accordance with embodiments of this disclosure;

FIG. 2 is an exploded view of the airflow control device of FIG. 1 showing a base portion and a cap portion thereof, in accordance with embodiments of this disclosure;

FIG. 3 is a bottom view of the base portion of the airflow control device of FIG. 1, in accordance with embodiments of this disclosure;

FIG. 4 is a top view of the base portion of the airflow control device of FIG. 1, in accordance with embodiments of this disclosure;

FIG. 5 is a side view of the airflow control device of FIG. 1 in the assembled state, in accordance with embodiments of this disclosure;

FIG. 6 is a side cross-sectional view of the airflow control device of FIG. 1 in the assembled state, in accordance with embodiments of this disclosure;

FIG. 7 is a side view of a system that includes the airflow control device of FIG. 1 in operation, in accordance with embodiments of this disclosure;

FIG. 8 is a perspective view of another airflow control device in an assembled state, in accordance with embodiments of this disclosure;

FIG. 9 is an exploded view of the airflow control device of FIG. 8, in accordance with embodiments of this disclosure;

FIG. 10 is a bottom view of the base portion of the airflow control device of FIG. 8, in accordance with embodiments of this disclosure;

FIG. 11 is a side view of the airflow control device of FIG. 8 in the assembled state, in accordance with embodiments of this disclosure;

FIG. 12 is a side cross-sectional view of the airflow control device of FIG. 8 in the assembled state, in accordance with embodiments of this disclosure;

FIG. 13 is a side view of a system that includes the airflow control device of FIG. 8 in operation, in accordance with embodiments of this disclosure;

FIG. 14 is a perspective view of an additional airflow control device in an assembled state, in accordance with embodiments of this disclosure;

FIG. 15 is an exploded view of the airflow control device of FIG. 14, in accordance with embodiments of this disclosure;

FIG. 16 is a bottom view of the base portion of the airflow control device of FIG. 14, in accordance with embodiments of this disclosure;

FIG. 17 is a side view of the airflow control device of FIG. 14 in an assembled state, in accordance with embodiments of this disclosure;

FIG. 18 is a side cross-sectional view of the airflow control device of FIG. 14 in an assembled state, in accordance with embodiments of this disclosure; and

FIG. 19 is a side view of a system that includes the airflow control device of FIG. 14 in operation, in accordance with embodiments of this disclosure.

### DETAILED DESCRIPTION

In the Brief Summary above and in the Detailed Description, the claims below, and in the accompanying drawings, reference is made to particular features (including method acts) of the present disclosure. It is to be understood that the disclosure includes all possible combinations of such particular features. For example, where a particular feature is disclosed in the context of a particular embodiment, or a particular claim, that feature can also be used, to the extent possible, in combination with and/or in the context of other particular aspects and embodiments described herein.

The following description provides specific details, such as components, assembly, and materials in order to provide a thorough description of embodiments of the disclosure. However, a person of ordinary skill in the art will understand that the embodiments of the disclosure may be practiced without employing these specific details.

The use of the term “for example,” means that the related description is explanatory, and though the scope of the disclosure is intended to encompass the examples and legal equivalents, the use of such terms is not intended to limit the scope of an embodiment or this disclosure to the specified components, acts, features, functions, or the like.

Drawings presented herein are for illustrative purposes, and are not necessarily meant to be actual views of any particular material, component, structure, or device. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale. Additionally, elements common between figures may retain the same numerical designation.

As used herein, the term “configured” refers to a size, shape, material composition, material distribution, orientation, and/or arrangement of one or more of at least one structure and at least one apparatus facilitating operation of one or more of the structure and the apparatus in a predetermined way.

As used herein, the terms “comprising” and “including,” and grammatical equivalents thereof include both open-ended terms that do not exclude additional, unrecited elements or method acts, and more restrictive terms such as “consisting of” and “consisting essentially of” and grammatical equivalents thereof.

As used herein, the term “may” with respect to a material, structure, feature, or method act indicates that such is contemplated for use in implementation of an embodiment of the disclosure and such term is used in preference to the more restrictive term “is” so as to avoid any implication that other, compatible materials, structures, features and methods usable in combination therewith should or must be excluded.

As used herein, the singular forms “a,” “an,” and “the” include the plural forms as well, unless the context clearly indicates otherwise.

As used herein, the term “and/or” includes any and all combinations of one or more of the associated listed items.

As used herein, relational terms, such as “first,” “second,” etc., are used for clarity and convenience in understanding the disclosure and accompanying drawings and does not connote or depend on any specific preference, orientation, or order, except where the context clearly indicates otherwise.

As used herein, the term “about,” when used in reference to a numerical value for a particular parameter, is inclusive of the numerical value and a degree of variance from the numerical value that one of ordinary skill in the art would understand is within acceptable tolerances for the particular parameter. For example, “about,” in reference to a numerical value, may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

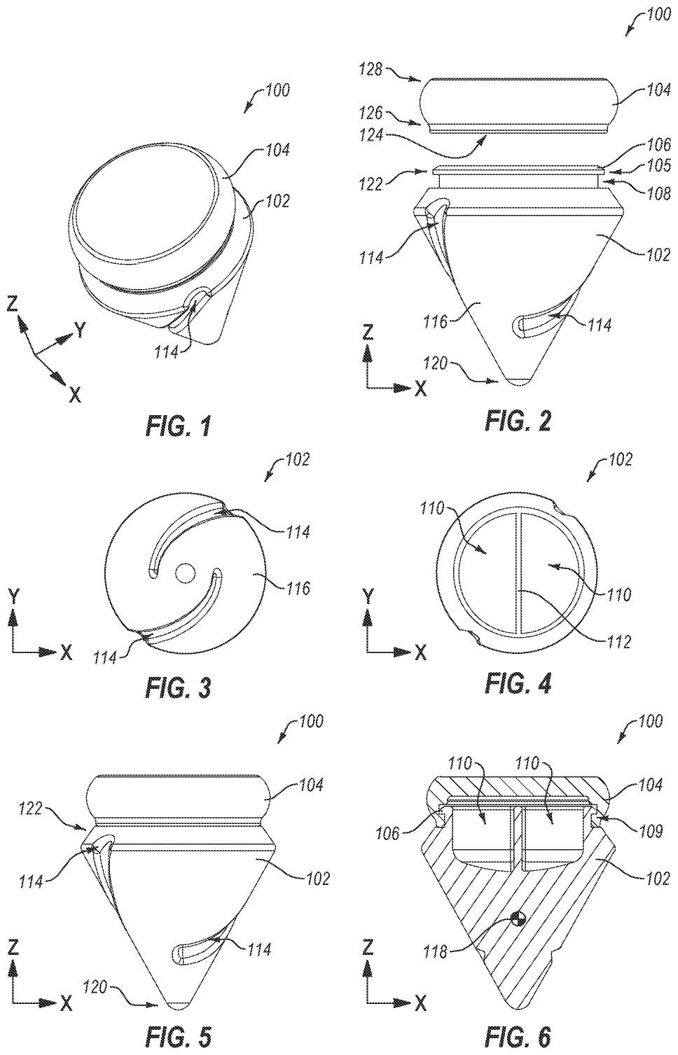

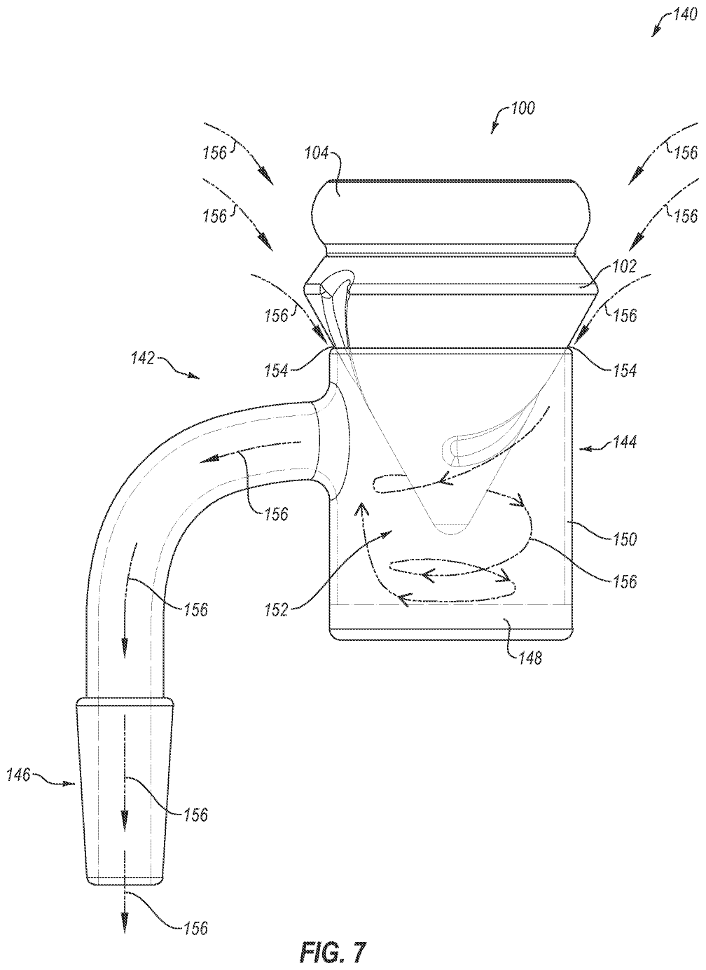

FIGS. 1-6 show various views of an airflow control device 100, in accordance with embodiments of this disclosure. The airflow control device 100 may be utilized in the context of vaporizing and/or smoking, although the use of the airflow control device 100 is in no way limited to the vaporizing and/or smoking context. In the vaporizing and/or smoking context, the airflow control device 100 may function as what is colloquially referred to as a “carb cap.” Thus, the airflow control device 100 may be utilized to control airflow, pressure, and/or temperature of air, vapors, and/or smoke through a vaporizing and/or smoking device (e.g., a pipe, etc.). This process is shown and described below with respect to FIG. 7.

Referring collectively to FIGS. 1-6, the airflow control device 100 generally includes a base portion 102 and a cap portion 104 configured to removably connect to the base portion 102. The base portion 102 may include a connection feature 105 (e.g., a lip 106 and a recessed section 108), and the cap portion 104 may include a corresponding connection feature 109 (shown in FIG. 6) configured to engage the connection feature 105 (e.g., the lip 106 and the recessed section 108) of the base portion 102 to facilitate a secure connection. While the connection feature 105 of the base portion 102 and the connection feature 109 of the cap portion 104 are shown as including lips and recesses, any features suitable for connecting the base portion 102 and the cap portion 104 may be used. As non-limiting examples, the connection feature 105 of the base portion 102 may include threads, pins, openings, etc. and the connection feature 109 of the cap portion 104 may include corresponding (e.g., complementary) threads, openings, pins, etc.

Since the base portion 102 is configured to removably connect to the cap portion 104, the airflow control device 100 may include both a disassembled state, in which the cap portion 104 is disconnected from the base portion 102, and an assembled state, in which the cap portion 104 is connected (e.g., secured) to the base portion 102. The cap portion 104 may be removable from the base portion 102 such that the airflow control device 100 can transition between the assembled state and the disassembled state.

The base portion 102 may define one or more internal cavities 110 (two shown in FIG. 4). For example, as shown in FIG. 4, the base portion 102 may include two of the internal cavities 110 separated by a central member 112. In addition, the base portion 102 may define one or more channel(s) 114 (two shown in FIGS. 1-6) on an exterior surface 116 of the base portion 102.

The base portion 102 of the airflow control device 100 may exhibit any desired shape. For example, as shown in FIGS. 1-6, the base portion 102 may exhibit a generally conical shape. In additional embodiments, the base portion 102 may exhibit a chisel shape, a frustoconical shape, a conical shape, a dome shape, an elliptical cylinder shape, a circular cylinder shape, a pillar shape, a truncated version of one of the foregoing shapes, or a combination of two or more of the foregoing shapes.

The base portion 102 of the airflow control device 100 may be made of and/or include any desired materials. For example, the base portion 102 may include one or more metals (e.g., stainless steel, titanium, aluminum, metal alloys, etc.), glasses (e.g., soda-lime, borosilicate, fiberglass, aluminosilicate, non-silicate, etc.), ceramics (e.g., quartz, aluminum oxide, clay, porcelain, etc.), polymers (e.g., hemp, shellac, amber, wool, silk, natural rubber, cellulose, polyethylene, polypropylene, polystyrene, polyvinyl chloride, synthetic rubber, phenol formaldehyde resin (or Bakelite), neoprene, nylon, polyacrylonitrile, PVB, silicone, plastics (e.g., fiberglass), composite wood, concrete, etc.).

In some embodiments, the base portion 102 may be made or and/or include a single material. In some embodiments, part (e.g., a lower half) of the base portion 102 may be made of and/or include a first material, and a second part (e.g., an upper half) of the base portion 102 may be made of and/or include a second material. In addition, the base portion 102 may be made of and/or include any quantities of the first material and the second material. For example, the base portion 102 may include from about 0% to about 100% of the first material, such as about 5%, about 10%, about 15%, about 20%, about 25% about 30%, about 35%, about 40%, about 45%, about 50%, about 55%, about 60%, about 65%, about 70%, about 75%, about 80%, about 85%, about 90%, or about 95% of the first material. In addition, the base portion 102 may include from about 100% to about 0% of the second material, such as about 95%, about 90%, about 85%, about 80%, about 75%, about 70%, about 65%, about 60%, about 55%, about 50%, about 45%, about 40%, about 35%, about 30%, about 25%, about 20%, about 15%, about 10%, or about 5% of the second material. In further embodiments, the base portion 102 may be made of and/or include three or more different materials.

Accordingly, as shown in FIG. 6, the base portion 102 may be tailored such that the center of mass 118 of the base portion 102 is in the bottom half, such as the bottom third, or the bottom quartile of the base portion 102 to facilitate stability when the airflow control device 100 is in operation.

The channels 114 of the base portion 102 may be configured to direct airflow alongside the base portion 102. For example, when the airflow control device 100 is in use, airflow may be directed from proximate the cap portion 104 to the base portion 102 through the channels 114 on the exterior surface 116 of the base portion 102.

The channels 114 may exhibit any desired shape and size. For example, a cross-sectional shape of one of the channels 114 taken along a length of the channel 114 may exhibit an elliptical shape, a circular shape, a tetragonal shape (e.g., square, rectangular, trapezium, trapezoidal, parallelogram, etc.), a triangular shape, a semicircular shape, an ovular shape, a semicircular shape, a tombstone shape, a tear drop shape, a crescent shape, or a combination of two or more of the foregoing shapes. In addition, the channels 114 may get larger or smaller along the length of the channel 114 such that the cross-section may change (e.g., gradually or abruptly) along the length of the channel 114.

The channels 114 may extend along dimension(s) (e.g., a height in the Z-direction, and/or a lateral dimension in the X-direction and/or Y-direction) of the base portion 102. For example, the channels 114 may extend from proximate a first end 120 (e.g., a lower end) of the base portion 102 to proximate a second end 122 (e.g., an upper end) of the base portion 102. As shown in FIG. 4, the channels 114 may be helical channels that extend both vertically (e.g., in the Z-direction) and laterally (e.g., in the X-direction and/or the Y-direction) along the base portion 102. In some embodiments, the channels 114 may extend from sides of the base portion 102 to proximate the center of the base portion 102 (e.g., in the X-direction and/or Y-direction).

The depth (e.g., maximum depth) of the channels 114 (e.g., measured from the exterior surface 116 of the base portion 102) may be within a range of from about 5% to about 25% of maximum lateral and/or vertical dimensions (e.g., in the X-direction, Y-direction, and/or Z-direction) of the base portion 102. For example, the depth of the channels 114 may be about 5%, about 10%, about 15%, about 20%, or about 25% of the maximum lateral dimension(s) (e.g., in the X-direction and/or the Y-direction) of the base portion 102. The depth of the channels 114 may be within a range of from about 0.5 mm to about 3 mm, such as about 0.5 mm, about 1 mm, about 1.5 mm, about 2 mm, about 2.5 mm, or about 3 mm.

The internal cavities 110 may exhibit any desired shape and/or size. As shown in FIGS. 4 and 6, the internal cavities 110 exhibit a generally half-dome shape. However, this disclosure is not so limited. One or more of the internal cavities 110 may exhibit a chisel shape, a frustoconical shape, a conical shape, a dome shape, half-dome shape, an elliptical cylinder shape, a rectangular cylinder shape, a circular cylinder shape, a pyramidal shape, a frusto pyramidal shape, a fin shape, a pillar shape, a stud shape, a truncated version of one of the foregoing shapes, or a combination of two or more of the foregoing shapes. Accordingly, the walls of the base portion 102 may define the internal cavities 110 to have any desired cross-sectional shape (e.g., taken in the X-Y plane, the X-Z plane, and/or the Y-Z plane) including, but not limited to, an elliptical shape, a circular shape, a tetragonal shape (e.g., square, rectangular, trapezium, trapezoidal, parallelogram, etc.), a triangular shape, a semicircular shape, an ovular shape, a semicircular shape, a tombstone shape, a tear drop shape, a crescent shape, or a combination of two or more of the foregoing shapes. The shape of the base portion 102 defining the internal cavities 110 may be symmetric, or may be asymmetric. In addition, in embodiments that include multiple internal cavities 110, the shape of the internal cavities 110 may be the same shape as one another, different from one another, and/or one or more of the internal cavities 110 may exhibit the same shape as one another, whereas others of the internal cavities 110 exhibit different shapes from one another. For example, one of the internal cavities 110 may be customized to contain smoking and/or vaporizing products, and another of the internal cavities 110 may be customized to contain elements for the smoking and/or vaporizing device, such as, for example, a “terp” ball.

The internal cavities 110 defined by the base portion 102 may also exhibit any desired size. For example, the maximum lateral dimensions (e.g., in the X-direction and/or Y-direction) of the internal cavities 110 may be within a range of from about 50% to about 95% of the maximum lateral dimensions of the base portion 102, such as about 50%, about 60%, about 70%, about 75%, about 80%, about 85%, about 90%, or about 95% of the maximum lateral dimensions of the base portion 102. The maximum lateral dimensions of the internal cavities 110 may be within a range of from about 5 millimeters (mm) to about 10 mm, such as about 5 mm, about 6 mm, about 7 mm, about 8 mm, about 9 mm, or about 10 mm. The maximum depth of the internal cavities 110 may be within a range of from about 15% to about 50% of the vertical dimension or height (e.g., in the Z-direction) of the base portion 102, such as about 15%, about 20%, about 25%, about 30%, about 35%, about 40%, about 45%, or about 50% of the vertical dimension or height of the base portion 102. The depth (e.g., a maximum depth) of the internal cavities 110 may be within a range of from about 5 mm to about 10 mm, such as about 5 mm, about 6 mm, about 7 mm, about 8 mm, about 9 mm, or about 10 mm. In some embodiments, one or more of the internal cavities 110 may be sized, shaped, and/or configured to receive at least one spherical element having a diameter of about 9 mm. The spherical element(s) may be colloquially referred to as “terp ball(s)” or “terp pearl(s),” which may be utilized in combination with the airflow control device 100 to facilitate mixing of the air within a smoking device (e.g., a pipe, etc.).

The cap portion 104 is configured removably connect to the base portion 102 of the airflow control device 100. The cap portion 104 of the airflow control device 100 may exhibit any desired shape. For example, as shown in FIGS. 1-6, the cap portion 104 may exhibit a generally cylindrical shape defining a recess 124 within a first end 126 (e.g., a connection end) opposite a second end 128 (e.g., a free end). In additional embodiments, the cap portion 104 may exhibit a frustoconical shape, a conical shape, a dome shape, an elliptical cylinder shape, a circular cylinder shape, a pillar shape, a truncated version of one of the foregoing shapes, or a combination of two or more of the foregoing shapes.

The cap portion 104 of the airflow control device 100 may be made of and/or include any desired materials. For example, the cap portion 104 may include one or more metals (e.g., stainless steel, titanium, aluminum, metal alloys, etc.), glasses (e.g., soda-lime, borosilicate, fiberglass, aluminosilicate, non-silicate, etc.), ceramics (e.g., quartz, aluminum oxide, clay, porcelain, etc.), polymers (e.g., hemp, shellac, amber, wool, silk, natural rubber, cellulose, polyethylene, polypropylene, polystyrene, polyvinyl chloride, synthetic rubber, phenol formaldehyde resin (or Bakelite), neoprene, nylon, polyacrylonitrile, PVB, silicone, etc.), and/or composites (e.g., metal matrix composites, ceramic matrix composites, reinforced plastics (e.g., fiberglass), composite wood, concrete, etc.).

In some embodiments, the cap portion 104 may be made of and/or comprise the same material(s) as the base portion 102. In additional embodiments, the cap portion 104 may be made of and/or comprise different material(s) than the base portion 102.

In some embodiments, the base portion 102 and/or the cap portion 104 may be formed utilizing conventional manufacturing processes. For example, the base portion 102 and/or the cap portion 104 may be formed via casting, molding, etc., to include the geometry (e.g., size, shape, internal cavities, etc.) of the desired final product. The base portion 102 and/or the cap portion 104 may then undergo one or more material removal processes (e.g., turning, milling, drilling, etc.) to remove excess material and finalize the desired geometry of the base portion 102 and/or the cap portion 104. Afterwards, the base portion 102 and/or the cap portion 104 may undergo material finishing processes (e.g., grinding, polishing, abrasive blasting (e.g., sand blasting), coating (e.g., powder coating, dip coating, etc.), plating (e.g., electroplating, electroless plating, etc.)) to finalize the surface roughness, texture, and overall aesthetic of the base portion 102 and/or the cap portion 104.

In additional embodiments, the base portion 102 and/or the cap portion 104 may be formed utilizing one or more additive manufacturing processes, such as, for example, binder jetting, inkjet 3D printing, directed metal deposition, micro-plasma powder deposition, direct laser sintering, selective laser sintering, selective laser melting, electron beam melting, electron beam freeform fabrication, laminated object manufacturing, stereolithography, etc. For example, a controller may slice a three-dimensional model (e.g., a 3D CAD model) into layers via a conventional process to create a substantially two-dimensional image of each layer including a thickness of each layer. In some embodiments, liquid resin (e.g., including a photoreactive material) may be preheated to a desired viscosity, and the liquid resin may be deposited where required to form the first layer. Support structures may be printed simultaneously with the part for stability during printing. The deposited material is then exposed to UV light, which cures and solidifies the layer of material. Once the first layer has solidified, the build platform may be lowered by one layer heights and the process is repeated until the part is finished.

FIG. 7 is a side view of a system 140 that includes the airflow control device of FIG. 1 in operation, in accordance with embodiments of this disclosure. The system 140 generally includes the airflow control device 100 and a pipe 142. The pipe 142 includes a first end 144 and a second end 146 opposite the first end 144. The first end 144 may include a base 148 and sidewalls 150 extending from the base 148 that define a central cavity 152. For example, the first end 144 may exhibit a generally cylindrical shape and the central cavity 152 may be configured to receive at least a portion of the airflow control device 100. For example, the central cavity 152 may be sized, shaped, and configured to receive at least part of the base portion 102 of the airflow control device 100.

As shown in FIG. 7, at least another part of the base portion 102 of the airflow control device 100 is resting on a surface 154 (e.g., an upper surface) of the sidewalls 150 of the first end 144 of the pipe 142, such that at least part of the base portion 102 of the airflow control device 100 is received within the central cavity 152 of the pipe 142. In some embodiments, the at least another part of the base portion 102 that rests on the surface 154 of the sidewalls 150 may include a stabilization feature, such as a groove, ridge, rib, etc., configured to interface with (e.g., engage) the surface 154 of the sidewalls 150 to inhibit (e.g., prevent) lateral movement (e.g., translation in the X-direction and/or Y-direction), while still enabling rotational movement (e.g., in the X-Y plane) about the sidewalls 150. For example, the stabilization feature may extend around at least part of the periphery of the base portion 102 and may be configured (e.g., sized, shaped, etc.) to rest on the surface 154 of the sidewalls 150. The stabilization feature may at least partially stabilize the airflow control device 100 during movement (e.g., rotational movement) of the airflow control device 100.

The shape of the first end 144 of the pipe 142 (e.g., the shape of the sidewalls 150) may be complementary to the shape of the base portion 102 of the airflow control device 100 to effectively control (e.g., inhibit or restrict) the flow of air 156 that may be drawn through the pipe 142 during use. Thus, during use, the channels 114 may be the only paths that air outside of the system 140 can take to pass into the first end 144 of the pipe 142 and through the pipe 142 to the second end 146, where the air exits the pipe 142. Accordingly, the channels 114 may be configured to direct airflow from outside the first end 144 of the pipe 142, along the channels 114 and the base portion 102 of the airflow control device 100, and inside of the first end 144 of the pipe 142. In addition, the airflow control device 100 may increase the pressure and facilitate mixing of the air 156 within the first end 144 of the pipe 142 during use. The size and/or shape of the channels 114 may directly influence the pressure and/or mixing of the air 156 within the pipe 142, so the size and/or shape of the channels 114 of the airflow control device 100 may be tailored based on a desired functionality during use.

During use, a suction force may be created at the second end 146 of the pipe 142, which may draw the air 156 proximate the first end 144 of the pipe 142 into the pipe 142 via the channels 114. The air 156 may travel along the channels 114, which as shown in FIG. 7, may create a helical airflow pattern to facilitate mixing of the air 156 within the first end 144 of the pipe 142. The flow of the air 156 moving through the channels 114 may generate a force (e.g., a rotational force) acting on the base portion 102. The force may be sufficiently strong to rotate the base portion 102, which may further facilitate mixing of the air 156 and/or regulate temperature of the air 156.

The first end 144 of the pipe 142 may include a substance (e.g., a concentrate, such as a “dab”) at the base 148 of the first end 144 of the pipe within the central cavity 152. Accordingly, an exterior surface of the base 148 may be heated (e.g., via a flame, such as from a lighter) to vaporize and/or combust the substance, that may mix with the air 156 to form a substantially homogenous mixture (e.g., homogenous in composition, temperature, etc.) of the air 156 and vapor and/or smoke that then travels through the remainder of the pipe 142 and out of the second end 146 of the pipe 142.

In some embodiments, the first end 144 of the pipe 142 may additionally include one or more spherical element(s) (e.g., “terp ball(s)” or “terp pearl(s)”) that may rotate around the base 148 the first end 144 of the pipe 142 to further facilitate mixing of the air 156 and, optionally, another substance (e.g., a concentrate, such as a “dab”) that may be positioned at the base 148 of the first end 144. After the air 156 has been mixed to evenly distribute the temperature and, optionally, another substance throughout the air 156, the air 156 (e.g., the substantially homogenous air-substance mixture) may travel through the pipe 142 and exit through the second end 146.

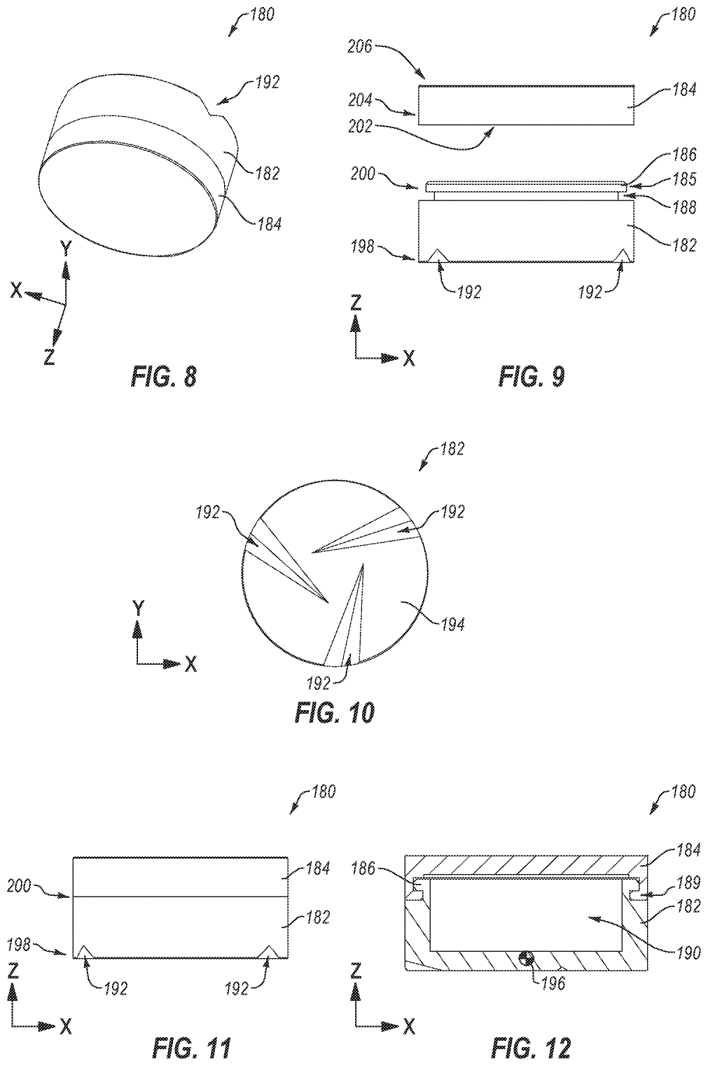

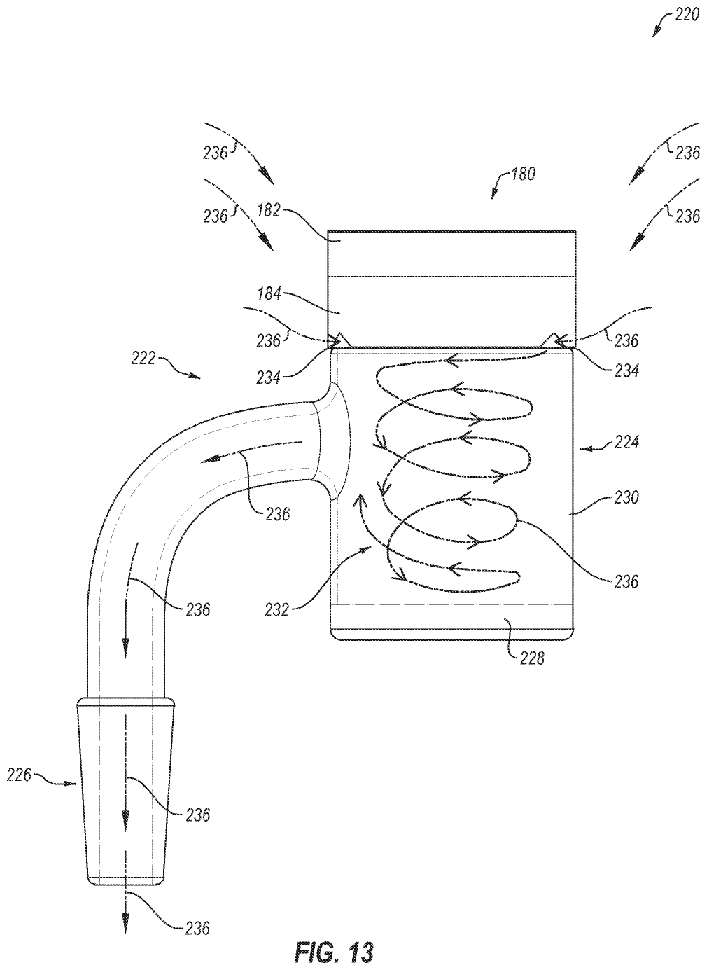

FIGS. 8-12 show various views of another airflow control device 180, in accordance with embodiments of this disclosure. The airflow control device 180 may be utilized in the context of vaporizing and/or smoking, although the use of the airflow control device 180 is in no way limited to the vaporizing and/or smoking context. In the vaporizing and/or smoking context, the airflow control device 180 may function as a “carb cap.” Thus, the airflow control device 180 may be utilized to control airflow, pressure, and/or temperature of air, vapors, and/or smoke through a vaporizing and/or smoking device (e.g., a pipe, etc.). This process is shown and described below with respect to FIG. 13.

Referring collectively to FIGS. 8-12, the airflow control device 180 generally includes a base portion 182 and a cap portion 184 configured to removably connect to the base portion 182. The base portion 182 may include a connection feature 185 (e.g., a lip 186 and a recessed section 188), and the cap portion 184 may include a corresponding connection feature 189 (shown in FIG. 12) configured to engage the connection feature 185 (e.g., the lip 186 and the recessed section 188) of the base portion 182 to facilitate a secure connection. While the connection feature 185 of the base portion 182 and the connection feature 189 of the cap portion 184 are shown as including lips and recesses, any features suitable for connecting the base portion 182 and the cap portion 184 may be used. As non-limiting examples, the connection feature 185 of the base portion 182 may include threads, pins, openings, etc. and the connection feature 189 of the cap portion 184 may include corresponding (e.g., complementary) threads, openings, pins, etc.

Since the base portion 182 is configured to removably connect to the cap portion 184, the airflow control device 180 may include both a disassembled state, in which the cap portion 184 is disconnected from the base portion 182, and an assembled state, in which the cap portion 184 is connected (e.g., secured) to the base portion 182. The cap portion 184 may be removable from the base portion 182 such that the airflow control device 180 can transition between the assembled state and the disassembled state.

The base portion 182 may define one or more internal cavities 190 (one shown in FIG. 12). In addition, the base portion 182 may define one or more channel(s) 192 (three shown in FIGS. 8-12) on an exterior surface 194 (e.g., bottom surface) of the base portion 182.

The base portion 182 of the airflow control device 180 may exhibit any desired shape. For example, as shown in FIGS. 8-12, the base portion 182 may exhibit a generally cylindrical. In additional embodiments, the base portion 182 may exhibit a chisel shape, a frustoconical shape, a conical shape, a dome shape, an elliptical cylinder shape, a circular cylinder shape, a pillar shape, a truncated version of one of the foregoing shapes, or a combination of two or more of the foregoing shapes.

The base portion 182 of the airflow control device 180 may be made of and/or include any desired materials. For example, the base portion 182 may include one or more metals (e.g., stainless steel, titanium, aluminum, metal alloys, etc.), glasses (e.g., soda-lime, borosilicate, fiberglass, aluminosilicate, non-silicate, etc.), ceramics (e.g., quartz, aluminum oxide, clay, porcelain, etc.), polymers (e.g., hemp, shellac, amber, wool, silk, natural rubber, cellulose, polyethylene, polypropylene, polystyrene, polyvinyl chloride, synthetic rubber, phenol formaldehyde resin (or Bakelite), neoprene, nylon, polyacrylonitrile, PVB, silicone, etc.), and/or composites (e.g., metal matrix composites, ceramic matrix composites, reinforced plastics (e.g., fiberglass), composite wood, concrete, etc.).

In some embodiments, the base portion 182 may be made or and/or include a single material. In some embodiments, part (e.g., a lower half) of the base portion 182 may be made of and/or include a first material, and a second part (e.g., an upper half) of the base portion 182 may be made of and/or include a second material. In addition, the base portion 182 may be made of and/or include any quantities of the first material and the second material. For example, the base portion 182 may include from about 0% to about 100% of the first material, such as about 5%, about 10%, about 15%, about 20%, about 25% about 30%, about 35%, about 40%, about 45%, about 50%, about 55%, about 60%, about 65%, about 70%, about 75%, about 80%, about 85%, about 90%, or about 95% of the first material. In addition, the base portion 102 may include from about 100% to about 0% of the second material, such as about 95%, about 90%, about 85%, about 80%, about 75%, about 70%, about 65%, about 60%, about 55%, about 50%, about 45%, about 40%, about 35%, about 30%, about 25%, about 20%, about 15%, about 10%, or about 5% of the second material. In further embodiments, the base portion 182 may be made of and/or include three or more different materials.

Accordingly, as shown in FIG. 12, the center of mass 196 of the base portion 182 may be tailored to be in the bottom half, such as the bottom third, or the bottom quartile of the base portion 182 to facilitate stability when the airflow control device 180 is in operation.

The channels 192 of the base portion 182 may be configured to direct airflow alongside the base portion 182. For example, when the airflow control device 180 is in use, airflow may be directed from proximate the cap portion 184 to the base portion 182 through the channels 192 on the exterior surface 194 of the base portion 182.

The channels 192 may exhibit any desired shape and size. For example, a cross-sectional shape of one of the channels 192 taken along a length of the channel 192 may exhibit an elliptical shape, a circular shape, a tetragonal shape (e.g., square, rectangular, trapezium, trapezoidal, parallelogram, etc.), a triangular shape, a semicircular shape, an ovular shape, a semicircular shape, a tombstone shape, a tear drop shape, a crescent shape, or a combination of two or more of the foregoing shapes. In addition, the channels 192 may get larger or smaller along the length of the channel 192 such that the cross-section may change (e.g., gradually or abruptly) along the length of the channel 192.

The channels 192 may extend along dimension(s) (e.g., a height in the Z-direction, and/or a lateral dimension in the X-direction and/or Y-direction) of the base portion 182. For example, the channels 192 may extend from proximate a first end 198 (e.g., lower end) of the base portion 182 to proximate a second end 200 (e.g., an upper end) of the base portion 182. As shown in FIG. 10, the channels 192 may be generally straight triangular cross-section that extend laterally (e.g., in the X-direction and/or the Y-direction) along the base portion 182. In some embodiments, the channels 192 may extend from sides of the base portion 182 to proximate the center of the base portion 182 (e.g., in the X-direction and/or Y-direction). As shown in FIG. 10, the channels 192 are relatively straight and extend from an exterior edge of the base portion 182 to proximate the center of the base portion 182 (e.g., in the X-direction and Y-direction). The channels 192 may extend slightly further than the center of the base portion and be angled slightly away from the center to facilitate rotational airflow.

The depth (e.g., maximum depth) of the channels 192 (e.g., measured from the exterior surface 194 of the base portion 182) may be within a range of from about 5% to about 25% of maximum lateral and/or vertical dimensions (e.g., in the X-direction, Y-direction, and/or Z-direction) of the base portion 182. For example, the depth of the channels 192 may be about 5%, about 10%, about 15%, about 20%, or about 25% of the maximum vertical dimension (e.g., in the Z-direction) of the base portion 182. The depth of the channels 192 may be within a range of from about 0.5 mm to about 3 mm, such as about 0.5 mm, about 1 mm, about 1.5 mm, about 2 mm, about 2.5 mm, or about 3 mm.

The internal cavity 190 may exhibit any desired shape and/or size. The internal cavity 190 shown in FIG. 12 exhibits a generally cylindrical shape. However, this disclosure is not so limited. The internal cavity 190 may exhibit a chisel shape, a frustoconical shape, a conical shape, a dome shape, half-dome shape, an elliptical cylinder shape, a rectangular cylinder shape, a circular cylinder shape, a pyramidal shape, a frusto pyramidal shape, a fin shape, a pillar shape, a stud shape, a truncated version of one of the foregoing shapes, or a combination of two or more of the foregoing shapes. Accordingly, the walls of the base portion 182 may define the internal cavity 190 to have any desired cross-sectional shape (e.g., taken in the X-Y plane, the X-Z plane, and/or the Y-Z plane) including, but not limited to, an elliptical shape, a circular shape, a tetragonal shape (e.g., square, rectangular, trapezium, trapezoidal, parallelogram, etc.), a triangular shape, a semicircular shape, an ovular shape, a semicircular shape, a tombstone shape, a tear drop shape, a crescent shape, or a combination of two or more of the foregoing shapes. The shape of the base portion 182 defining the internal cavity 190 may be symmetric, or may be asymmetric. In addition, in embodiments 1 that include multiple internal cavities 190, the shape of the internal cavities 190 may be the same shape as one another, different from one another, and/or one or more of the internal cavities 190 may exhibit the same shape as one another, whereas others of the internal cavities 190 exhibit different shapes from one another.

The base portion 182 may also define the internal cavity 190 to be any desired size. For example, the maximum lateral dimensions (e.g., in the X-direction and/or Y-direction) of the internal cavity 190 may be within a range of from about 50% to about 95% of the maximum lateral dimensions of the base portion 182, such as about 50%, about 60%, about 70%, about 75%, about 80%, about 85%, about 90%, or about 95% of the maximum lateral dimensions of the base portion 182. The maximum lateral dimensions of the internal cavity 190 may be within a range of from about 5 millimeters (mm) to about 25 mm, such as about 5 mm, about 10 mm, about 15 mm, about 20 mm, or about 25 mm. The maximum depth of the internal cavity 190 may be within a range of from about 15% to about 50% of the vertical dimension or height (e.g., in the Z-direction) of the base portion 182, such as about 15%, about 20%, about 25%, about 30%, about 35%, about 40%, about 45%, or about 50% of the vertical dimension or height of the base portion 182. The depth (e.g., a maximum depth) of the internal cavity 190 may be within a range of from about 5 mm to about 10 mm, such as about 5 mm, about 6 mm, about 7 mm, about 8 mm, about 9 mm, or about 10 mm. In some embodiments, the internal cavity 190 may be sized, shaped, and/or configured to receive at least one spherical element having a diameter of about 9 mm. The spherical element(s) may be colloquially referred to as “terp ball(s)” or “terp pearl(s),” which may be utilized in combination with the airflow control device 180 to facilitate mixing of the air within a smoking device (e.g., a pipe, etc.).

The cap portion 184 is configured to removably connect to the base portion 182 of the airflow control device 180. The cap portion 184 of the airflow control device 180 may exhibit any desired shape. For example, as shown in FIGS. 8-12, the cap portion 184 may exhibit a generally cylindrical shape defining a recess 202 within a first end 204 (e.g., a connection end) opposite a second end 206 (e.g., a free end). In additional embodiments, the cap portion 184 may exhibit a frustoconical shape, a conical shape, a dome shape, an elliptical cylinder shape, a circular cylinder shape, a pillar shape, a truncated version of one of the foregoing shapes, or a combination of two or more of the foregoing shapes.

The cap portion 184 of the airflow control device 180 may be made of and/or include any desired materials. For example, the cap portion 184 may include one or more metals (e.g., stainless steel, titanium, aluminum, metal alloys, etc.), glasses (e.g., soda-lime, borosilicate, fiberglass, aluminosilicate, non-silicate, etc.), ceramics (e.g., quartz, aluminum oxide, clay, porcelain, etc.), polymers (e.g., hemp, shellac, amber, wool, silk, natural rubber, cellulose, polyethylene, polypropylene, polystyrene, polyvinyl chloride, synthetic rubber, phenol formaldehyde resin (or Bakelite), neoprene, nylon, polyacrylonitrile, PVB, silicone, plastics (e.g., fiberglass), composite wood, concrete, etc.).

In some embodiments, the cap portion 184 may be made of and/or comprise the same material(s) as the base portion 182. In additional embodiments, the cap portion 184 may be made of and/or comprise different material(s) than the base portion 182.

In some embodiments, the base portion 182 and/or the cap portion 184 may be formed utilizing conventional manufacturing processes. For example, the base portion 182 and/or the cap portion 184 may be formed via casting, molding, etc., to include the geometry (e.g., size, shape, internal cavities, etc.) of the desired final product. The base portion 182 and/or the cap portion 184 may then undergo one or more material removal processes (e.g., turning, milling, drilling, etc.) to remove excess material and finalize the desired geometry of the base portion 182 and/or the cap portion 184. Afterwards, the base portion 182 and/or the cap portion 184 may undergo material finishing processes (e.g., grinding, polishing, abrasive blasting (e.g., sand blasting), coating (e.g., powder coating, dip coating, etc.), plating (e.g., electroplating, electroless plating, etc.)) to finalize the surface roughness, texture, and overall aesthetic of the base portion 182 and/or the cap portion 184.

In additional embodiments, the base portion 182 and/or the cap portion 184 may be formed utilizing one or more additive manufacturing processes, such as, for example, binder jetting, inkjet 3D printing, directed metal deposition, micro-plasma powder deposition, direct laser sintering, selective laser sintering, selective laser melting, electron beam melting, electron beam freeform fabrication, laminated object manufacturing, stereolithography, etc. For example, a controller may slice a three-dimensional model (e.g., a 3D CAD model) into layers via a conventional process to create a substantially two-dimensional image of each layer including a thickness of each layer. In some embodiments, liquid resin (e.g., including a photoreactive material) may be preheated to a desired viscosity, and the liquid resin may be deposited where required to form the first layer. Support structures may be printed simultaneously with the part for stability during printing. The deposited material is then exposed to UV light, which cures and solidifies the layer of material. Once the first layer has solidified, the build platform may be lowered by one layer heights and the process is repeated until the part is finished.

FIG. 13 is a side view of a system 220 that includes the airflow control device of FIG. 8 in operation, in accordance with embodiments of this disclosure. The system 220 generally includes the airflow control device 180 and a pipe 222. The pipe 222 includes a first end 224 and a second end 226 opposite the first end 224. The first end 224 may include a base 228 and sidewalls 230 extending from the base 228 that define a central cavity 232.

As shown in FIG. 13, the base portion 182 of the airflow control device 180 may exhibit lateral dimensions (e.g., in the X-direction and/or Y-direction) that are at least as large as the lateral dimensions of the sidewalls 230 at the first end 224 of the pipe 222. For example, in some embodiments, the lateral dimensions of the base portion 182 of the airflow control device 180 may be substantially the same as the lateral dimensions of the sidewalls of the first end 224 of the pipe. In additional embodiments, the lateral dimensions of the base portion 182 of the airflow control device 180 may be larger than the lateral dimensions of the sidewalls of the first end of the pipe 222 such that the base portion 182 overhangs the sidewalls 230 of the pipe 222. In some embodiments, the at least a part of the base portion 182 that rests on the surface 234 of the sidewalls 230 may include a stabilization feature, such as a groove, ridge, rib, etc., configured to interface with (e.g., engage) the surface 234 of the sidewalls 230 to inhibit (e.g., prevent) lateral movement (e.g., translation in the X-direction and/or Y-direction), while still enabling rotational movement (e.g., in the X-Y plane) about the sidewalls 230. For example, the stabilization feature may extend around at least part of the periphery of the base portion 182 and may be configured (e.g., sized, shaped, etc.) to rest on the surface 234 of the sidewalls 230. The stabilization feature may at least partially stabilize the airflow control device 180 during movement (e.g., rotational movement) of the airflow control device 180. The stabilization feature may stabilize the airflow control device 180 during movement (e.g., rotational movement) of the airflow control device 180.

The shape of the first end 224 of the pipe 222 (e.g., the shape of the sidewalls 230) may be complementary to the shape of the base portion 182 of the airflow control device 180 to effectively control (e.g., inhibit or restrict) the flow of air 236 that may be drawn through the pipe 222 during use. Thus, during use, the channels 192 may be the only paths that air outside of the system 220 can take to pass into the first end 224 of the pipe 222 and through the pipe 222 to the second end 226, where the air exits the pipe 222. Accordingly, the channels 192 may be configured to direct airflow from outside the first end 224 of the pipe 222, along the channels 192 and the base portion 182 of the airflow control device 180, and inside of the first end 224 of the pipe 222. In addition, the airflow control device 180 may increase the pressure and facilitate mixing of the air 236 within the first end 224 of the pipe 222 during use. The size and/or shape of the channels 192 may directly influence the pressure and/or mixing of the air 236 within the pipe 222, so the size and/or shape of the channels 192 of the airflow control device 180 may be tailored based on a desired functionality during use.

During use, a suction force may be created at the second end 226 of the pipe 222, which may draw the air 236 proximate the first end 224 of the pipe 222 into the pipe 222 via the channels 192. The air 236 may travel along the channels 192, which as shown in FIG. 13, may create a helical airflow pattern to facilitate mixing of the air 236 within the first end 224 of the pipe 222. The flow of the air 236 moving through the channels 192 may generate a force (e.g., a rotational force) acting on the base portion 182. The force may be sufficiently strong to rotate the base portion 182, which may further facilitate mixing of the air 236 and/or regulate temperature of the air 236.

The first end 224 of the pipe 222 may include a substance (e.g., a concentrate, such as a “dab”) at the base 228 of the first end 224 of the pipe within the central cavity 232. Accordingly, an exterior surface of the base 228 may be heated (e.g., via a flame, such as from a lighter) to vaporize and/or combust the substance, that may mix with the air 236 to form a substantially homogenous mixture (e.g., homogenous in composition, temperature, etc.) of the air 236 and vapor and/or smoke that then travels through the remainder of the pipe 222 and out of the second end 226 of the pipe 222.

In some embodiments, the first end 224 of the pipe 222 may additionally include one or more spherical element(s) (e.g., “terp ball(s)” or “terp pearl(s)”) that may rotate around the base 228 the first end 224 of the pipe 222 to further facilitate mixing of the air 236 and, optionally, another substance (e.g., a concentrate, such as a “dab”) that may be positioned at the base 228 of the first end 224. After the air 236 has been mixed to evenly distribute the temperature and, optionally, another substance throughout the air 236, the air 236 (e.g., the substantially homogenous air-substance mixture) may travel through the pipe 222 and exit through the second end 226.

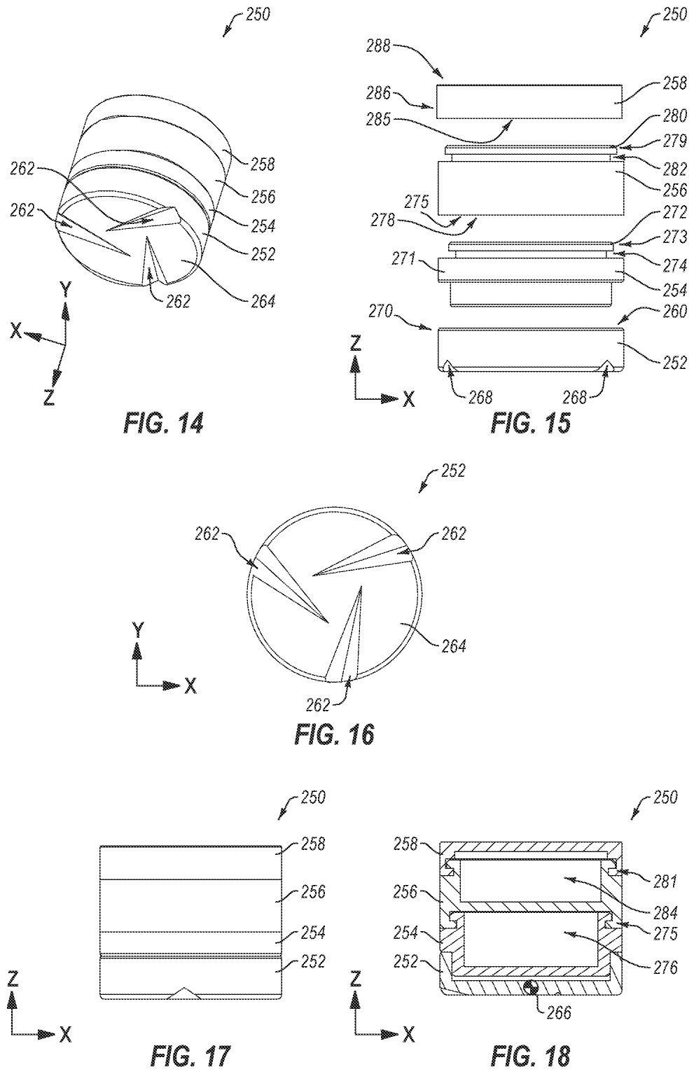

FIGS. 14-18 show various views of another airflow control device 250, in accordance with embodiments of this disclosure. The airflow control device 250 may be utilized in the context of vaporizing and/or smoking, although the use of the airflow control device 250 is in no way limited to the vaporizing and/or smoking context. In the vaporizing and/or smoking context, the airflow control device 250 may function as what is colloquially referred to as a “carb cap.” Thus, the airflow control device 250 may be utilized to control airflow, pressure, and/or temperature of air, vapors, and/or smoke through a vaporizing and/or smoking device (e.g., a pipe, etc.). This process is shown and described below with respect to FIG. 13.

Referring collectively to FIGS. 14-18, the airflow control device 250 generally includes a base portion 252, a first intermediate portion 254, a second intermediate portion 256, and a cap portion 258, that are each configured to removably connect to one another. Accordingly, the base portion 252 may be configured to indirectly connect to the cap portion 258. Thus, the airflow control device 250 may include a disassembled state, in which one or more of the base portion 252, the first intermediate portion 254, the second intermediate portion 256, and/or the cap portion 258 are disconnected from another. In additional, the airflow control device 250 may include an assembled state, in which the base portion 252, the first intermediate portion 254, the second intermediate portion 256, and/or the cap portion 258 are connected to one another. Each of the components are configured to removably connect to one another such that the airflow control device 250 can transition from the assembled position to the disassembled position, and vice versa.

The base portion 252 may include a recess 260 configured to receive at least part of the first intermediate portion 254. The base portion 252 may define one or more channel(s) 262 (three shown in FIGS. 14-18) on an exterior surface 264 (e.g., bottom surface) of the base portion 252.

As shown in FIG. 18, the center of mass 266 of the base portion 252 may be tailored to be in the bottom half, such as the bottom third, or the bottom quartile of the base portion 252 to facilitate stability when the airflow control device 250 is in operation.

To tailor the center of mass 266 of the base portion 252, the base portion 252 may be made or and/or include a single material. In some embodiments, part (e.g., a lower half) of the base portion 252 may be made of and/or include a first material, and a second part (e.g., an upper half) of the base portion 252 may be made of and/or include a second material. In addition, the base portion 252 may be made of and/or include any quantities of the first material and the second material. For example, the base portion 252 may include from about 0% to about 100% of the first material, such as about 5%, about 10%, about 15%, about 20%, about 25% about 30%, about 35%, about 40%, about 45%, about 50%, about 55%, about 60%, about 65%, about 70%, about 75%, about 80%, about 85%, about 90%, or about 95% of the first material. In addition, the base portion 102 may include from about 100% to about 0% of the second material, such as about 95%, about 90%, about 85%, about 80%, about 75%, about 70%, about 65%, about 60%, about 55%, about 50%, about 45%, about 40%, about 35%, about 30%, about 25%, about 20%, about 15%, about 10%, or about 5% of the second material. In further embodiments, the base portion 252 may be made of and/or include three or more different materials.

The channels 262 of the base portion 252 may be configured to direct airflow alongside the base portion 252. For example, when the airflow control device 250 is in use, airflow may be directed from proximate the cap portion 258 to the base portion 252 through the channels 262 on the exterior surface 264 of the base portion 252.

The channels 262 may exhibit any desired shape and size. For example, a cross-sectional shape of one of the channels 262 taken along a length of the channel 262 may exhibit an elliptical shape, a circular shape, a tetragonal shape (e.g., square, rectangular, trapezium, trapezoidal, parallelogram, etc.), a triangular shape, a semicircular shape, an ovular shape, a semicircular shape, a tombstone shape, a tear drop shape, a crescent shape, or a combination of two or more of the foregoing shapes. In addition, the channels 262 may get larger or smaller along the length of the channel 262 such that the cross-section may change (e.g., gradually or abruptly) along the length of the channel 262.

The channels 262 may extend along dimension(s) (e.g., a height in the Z-direction, and/or a lateral dimension in the X-direction and/or Y-direction) of the base portion 252. For example, in some embodiments, the channels 262 may extend from proximate a first end 268 (e.g., a lower end) of the base portion 252 to proximate a second end 270 (e.g., an upper end) of the base portion 252. As shown in FIG. 16, the channels 262 may be generally straight triangular cross-section channels that extend laterally (e.g., in the X-direction and/or the Y-direction) along the base portion 252. In some embodiments, the channels 262 may extend from sides of the base portion 252 to proximate the center of the base portion 252 (e.g., in the X-direction and/or Y-direction). As shown in FIG. 10, the channels 262 are relatively straight and extend from an exterior edge of the base portion 252 to proximate the center of the base portion 252 (e.g., in the X-direction and Y-direction). The channels 262 may extend slightly further than the center of the base portion and be angled slightly away from the center to facilitate rotational airflow.

The depth (e.g., maximum depth) of the channels 262 (e.g., measured from the exterior surface 264 of the base portion 252) may be within a range of from about 5% to about 25% of maximum lateral and/or vertical dimensions (e.g., in the X-direction, Y-direction, and/or Z-direction) of the base portion 252. For example, the depth of the channels 262 may be about 5%, about 10%, about 15%, about 20%, or about 25% of the maximum vertical dimension (e.g., in the Z-direction) of the base portion 252. The depth of the channels 262 may be within a range of from about 0.5 mm to about 3 mm, such as about 0.5 mm, about 1 mm, about 1.5 mm, about 2 mm, about 2.5 mm, or about 3 mm.

The first intermediate portion 254 may include a ridge 271, a first side of which may be configured to rest on the base portion 252, and a second side of which may be configured to rest on a surface of the second intermediate portion 256.

The first intermediate portion 254 may include a connection feature 273 (e.g., a lip 272 and a recessed section 274), and the second intermediate portion 256 may include a corresponding connection feature 275 (shown in FIG. 18) configured to engage the connection feature 273 (e.g., the lip 272 and the recessed section 274) of the first intermediate portion 254 to facilitate a secure connection. While the connection feature 273 of the first intermediate portion 254 and the connection feature 275 of the second intermediate portion 256 are shown as including lips and recesses, any features suitable for connecting the first intermediate portion 254 and the second intermediate portion 256 may be used. As non-limiting examples, the connection feature 273 of the first intermediate portion 254 may include threads, pins, openings, etc. and the connection feature 275 of the second intermediate portion 256 may include corresponding (e.g., complementary) threads, openings, pins, etc.

The first intermediate portion 254 may also define one or more internal cavities 276 (one shown in FIG. 18). The internal cavities 276 may exhibit any desired shape and/or size. As shown in FIG. 18, the internal cavities 276 exhibit a generally cylindrical shape. However, this disclosure is not so limited. The internal cavities 276 may exhibit a chisel shape, a frustoconical shape, a conical shape, a dome shape, half-dome shape, an elliptical cylinder shape, a rectangular cylinder shape, a circular cylinder shape, a pyramidal shape, a frusto pyramidal shape, a fin shape, a pillar shape, a stud shape, a truncated version of one of the foregoing shapes, or a combination of two or more of the foregoing shapes. Accordingly, the walls of the first intermediate portion 254 may define the internal cavities 276 to have any desired cross-sectional shape (e.g., taken in the X-Y plane, the X-Z plane, and/or the Y-Z plane) including, but not limited to, an elliptical shape, a circular shape, a tetragonal shape (e.g., square, rectangular, trapezium, trapezoidal, parallelogram, etc.), a triangular shape, a semicircular shape, an ovular shape, a semicircular shape, a tombstone shape, a tear drop shape, a crescent shape, or a combination of two or more of the foregoing shapes. The shape of the first intermediate portion 254 defining the internal cavities 276 may be symmetric, or may be asymmetric. In addition, in embodiments that include multiple internal cavities 276, the shape of the internal cavities 276 may be the same shape as one another, different from one another, and/or one or more of the internal cavities 276 may exhibit the same shape as one another, whereas others of the internal cavities 276 exhibit different shapes from one another.

The first intermediate portion 254 may also define the internal cavities 276 to be any desired size. For example, the maximum lateral dimensions (e.g., in the X-direction and/or Y-direction) of the internal cavities 276 may be within a range of from about 50% to about 95% of the maximum lateral dimensions of the first intermediate portion 254, such as about 50%, about 60%, about 70%, about 75%, about 80%, about 85%, about 90%, or about 95% of the maximum lateral dimensions of the first intermediate portion 254. The maximum lateral dimensions of the internal cavities 276 may be within a range of from about 5 millimeters (mm) to about 25 mm, such as about 5 mm, about 10 mm, about 15 mm, about 20 mm, or about 25 mm. The maximum depth of the internal cavities 276 may be within a range of from about 15% to about 50% of the vertical dimension or height (e.g., in the Z-direction) of the first intermediate portion 254, such as about 15%, about 20%, about 25%, about 30%, about 35%, about 40%, about 45%, or about 50% of the vertical dimension or height of the first intermediate portion 254. The depth (e.g., a maximum depth) of the internal cavities 276 may be within a range of from about 5 mm to about 10 mm, such as about 5 mm, about 6 mm, about 7 mm, about 8 mm, about 9 mm, or about 10 mm. In some embodiments, the internal cavities 276 may be sized, shaped, and/or configured to receive at least one spherical element having a diameter of about 9 mm. The spherical element(s) may be colloquially referred to as “terp ball(s)” or “terp pearl(s),” which may be utilized in combination with the airflow control device 250 to facilitate mixing of the air within a smoking device (e.g., a pipe, etc.).

In some embodiments, as shown in FIG. 18, the connection feature 275 of the second intermediate portion 256 may include a recess 278 on a first end of the second intermediate portion 256. The recess 278 may be configured to receive the connection feature 273 (e.g., the lip 272) of the first intermediate portion 254. The second intermediate portion 256 may include an additional connection feature 279 (e.g., an additional lip 280 and an additional recessed section 282), and the cap portion 258 may include a corresponding connection feature 281 (shown in FIG. 18) configured to engage the additional connection feature 279 (e.g., the additional lip 280 and the additional recessed section 282) to facilitate a secure connection. While the additional connection feature 279 of the second intermediate portion 256 and the connection feature 281 of the cap portion 258 are shown as including lips and recesses, any features suitable for connecting the second intermediate portion 256 and the cap portion 258 may be used. As non-limiting examples, the additional connection feature 279 of the second intermediate portion 256 may include threads, pins, openings, etc. and the connection feature 281 of the cap portion 258 may include corresponding (e.g., complementary) threads, openings, pins, etc.

The second intermediate portion 256 may also define one or more internal cavities 284 (one shown in FIG. 18). The internal cavities 284 may exhibit any desired shape and/or size. As shown in FIG. 18, the internal cavities 284 exhibit a generally cylindrical shape. However, this disclosure is not so limited. The internal cavities 284 may exhibit a chisel shape, a frustoconical shape, a conical shape, a dome shape, half-dome shape, an elliptical cylinder shape, a rectangular cylinder shape, a circular cylinder shape, a pyramidal shape, a frusto pyramidal shape, a fin shape, a pillar shape, a stud shape, a truncated version of one of the foregoing shapes, or a combination of two or more of the foregoing shapes. Accordingly, the walls of the second intermediate portion 256 may define the internal cavities 284 to have any desired cross-sectional shape (e.g., taken in the X-Y plane, the X-Z plane, and/or the Y-Z plane) including, but not limited to, an elliptical shape, a circular shape, a tetragonal shape (e.g., square, rectangular, trapezium, trapezoidal, parallelogram, etc.), a triangular shape, a semicircular shape, an ovular shape, a semicircular shape, a tombstone shape, a tear drop shape, a crescent shape, or a combination of two or more of the foregoing shapes. The shape of the second intermediate portion 256 defining the internal cavities 284 may be symmetric, or may be asymmetric. In addition, in embodiments that include multiple internal cavities 284, the shape of the internal cavities 284 may be the same shape as one another, different from one another, and/or one or more of the internal cavities 284 may exhibit the same shape as one another, whereas others of the internal cavities 284 exhibit different shapes from one another.

The second intermediate portion 256 may also define the internal cavities 284 to be any desired size. For example, the maximum lateral dimensions (e.g., in the X-direction and/or Y-direction) of the internal cavities 284 may be within a range of from about 50% to about 95% of the maximum lateral dimensions of the second intermediate portion 256, such as about 50%, about 60%, about 70%, about 75%, about 80%, about 85%, about 90%, or about 95% of the maximum lateral dimensions of the second intermediate portion 256. The maximum lateral dimensions of the internal cavities 284 may be within a range of from about 5 millimeters (mm) to about 25 mm, such as about 5 mm, about 10 mm, about 15 mm, about 20 mm, or about 25 mm. The maximum depth of the internal cavities 284 may be within a range of from about 15% to about 50% of the vertical dimension or height (e.g., in the Z-direction) of the second intermediate portion 256, such as about 15%, about 20%, about 25%, about 30%, about 35%, about 40%, about 45%, or about 50% of the vertical dimension or height of the second intermediate portion 256. The depth (e.g., a maximum depth) of the internal cavities 284 may be within a range of from about 5 mm to about 10 mm, such as about 5 mm, about 6 mm, about 7 mm, about 8 mm, about 9 mm, or about 10 mm. In some embodiments, the internal cavities 284 may be sized, shaped, and/or configured to receive at least one spherical element having a diameter of about 9 mm. The spherical element(s) may be colloquially referred to as “terp ball(s)” or “terp pearl(s),” which may be utilized in combination with the airflow control device 250 to facilitate mixing of the air within a smoking device (e.g., a pipe, etc.). Thus, the airflow control device 250 may include increased storage capacity relative to the airflow control device 180.

The cap portion 258 is configured to removably connect to the first intermediate portion 254 and/or the second intermediate portion 256 of the airflow control device 250. The cap portion 258 of the airflow control device 250 may exhibit any desired shape. For example, as shown in FIGS. 12-18, the cap portion 258 may exhibit a generally cylindrical shape defining a recess 285 within a first end 286 (e.g., a connection end) opposite a second end 288 (e.g., a free end). In additional embodiments, the cap portion 258 may exhibit a frustoconical shape, a conical shape, a dome shape, an elliptical cylinder shape, a circular cylinder shape, a pillar shape, a truncated version of one of the foregoing shapes, or a combination of two or more of the foregoing shapes.

The base portion 252, the first intermediate portion 254, the second intermediate portion 256, and/or the cap portion 258 of the airflow control device 250 may be made of and/or include any desired materials. For example, the base portion 252, the first intermediate portion 254, the second intermediate portion 256, and/or the cap portion 258 may include one or more metals (e.g., stainless steel, titanium, aluminum, metal alloys, etc.), glasses (e.g., soda-lime, borosilicate, fiberglass, aluminosilicate, non-silicate, etc.), ceramics (e.g., quartz, aluminum oxide, clay, porcelain, etc.), polymers (e.g., hemp, shellac, amber, wool, silk, natural rubber, cellulose, polyethylene, polypropylene, polystyrene, polyvinyl chloride, synthetic rubber, phenol formaldehyde resin (or Bakelite), neoprene, nylon, polyacrylonitrile, PVB, silicone, etc.), and/or composites (e.g., metal matrix composites, ceramic matrix composites, reinforced plastics (e.g., fiberglass), composite wood, concrete, etc.).

In some embodiments, each of the base portion 252, the first intermediate portion 254, the second intermediate portion 256, and/or the cap portion 258 may be made of and/or comprise the same material(s) as one another. In additional embodiments, one or more of the base portion 252, the first intermediate portion 254, the second intermediate portion 256, and/or the cap portion 258 may be made of and/or comprise different material(s) than one or more of the other components of the airflow control device 250.

In some embodiments, the base portion 252, the first intermediate portion 254, the second intermediate portion 256, and/or the cap portion 258 may be formed utilizing conventional manufacturing processes. For example, the base portion 252, the first intermediate portion 254, the second intermediate portion 256, and/or the cap portion 258 may be formed via casting, molding, etc., to include the geometry (e.g., size, shape, internal cavities, etc.) of the desired final product. The base portion 252, the first intermediate portion 254, the second intermediate portion 256, and/or the cap portion 258 may then undergo one or more material removal processes (e.g., turning, milling, drilling, etc.) to remove excess material and finalize the desired geometry of the base portion 252, the first intermediate portion 254, the second intermediate portion 256, and/or the cap portion 258. Afterwards, the base portion 252, the first intermediate portion 254, the second intermediate portion 256, and/or the cap portion 258 may undergo material finishing processes (e.g., grinding, polishing, abrasive blasting (e.g., sand blasting), coating (e.g., powder coating, dip coating, etc.), plating (e.g., electroplating, electroless plating, etc.)) to finalize the surface roughness, texture, and overall aesthetic of the base portion 252, the first intermediate portion 254, the second intermediate portion 256, and/or the cap portion 258.

In additional embodiments, the base portion 252, the first intermediate portion 254, the second intermediate portion 256, and/or the cap portion 258 may be formed utilizing one or more additive manufacturing processes, such as, for example, binder jetting, inkjet 3D printing, directed metal deposition, micro-plasma powder deposition, direct laser sintering, selective laser sintering, selective laser melting, electron beam melting, electron beam freeform fabrication, laminated object manufacturing, stereolithography, etc. For example, a controller may slice a three-dimensional model (e.g., a 3D CAD model) into layers via a conventional process to create a substantially two-dimensional image of each layer including a thickness of each layer. In some embodiments, liquid resin (e.g., including a photoreactive material) may be preheated to a desired viscosity, and the liquid resin may be deposited where required to form the first layer. Support structures may be printed simultaneously with the part for stability during printing. The deposited material is then exposed to UV light, which cures and solidifies the layer of material. Once the first layer has solidified, the build platform may be lowered by one layer heights and the process is repeated until the part is finished.

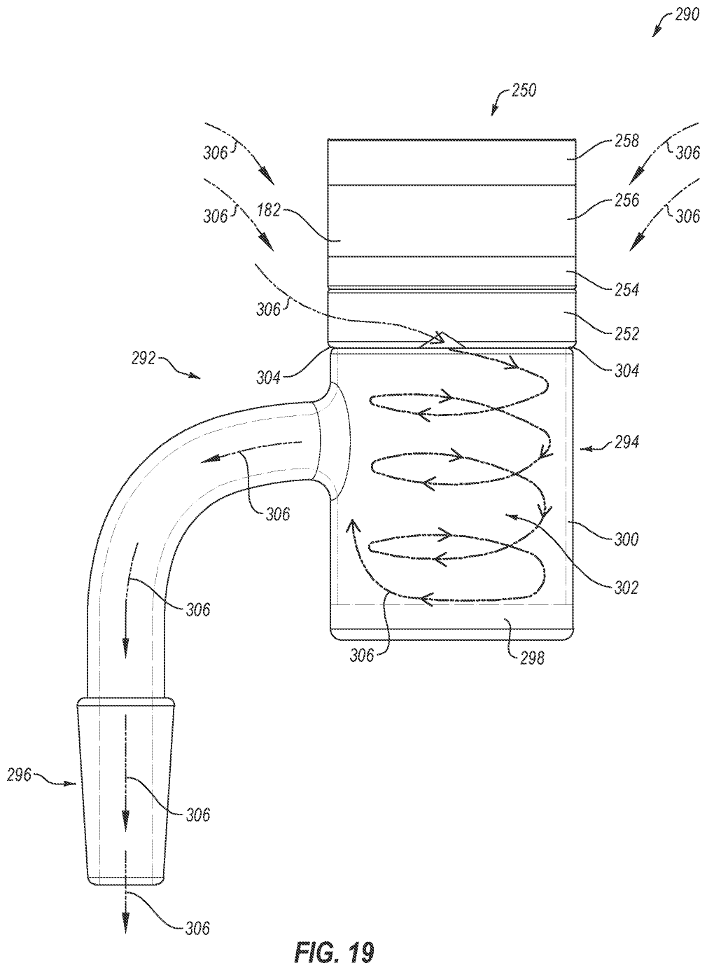

FIG. 19 is a side view of a system 290 that includes the airflow control device of FIG. 14 in operation, in accordance with embodiments of this disclosure. The system 290 generally includes the airflow control device 250 and a pipe 292. The pipe 292 includes a first end 294 and a second end 296 opposite the first end 294. The first end 294 may include a base 298 and sidewalls 300 extending from the base 298 that define a central cavity 302.

As shown in FIG. 19, the base portion 252 of the airflow control device 250 may exhibit lateral dimensions (e.g., in the X-direction and/or Y-direction) that are at least as large as the lateral dimensions of the sidewalls 300 at the first end 294 of the pipe 292. For example, in some embodiments, the lateral dimensions of the base portion 252 of the airflow control device 250 may be substantially the same as the lateral dimensions of the sidewalls of the first end 294 of the pipe. In additional embodiments, the lateral dimensions of the base portion 252 of the airflow control device 250 may be larger than the lateral dimensions of the sidewalls of the first end of the pipe 292 such that the base portion 252 overhangs the sidewalls 300 of the pipe 292. In some embodiments, the at least a part of the base portion 252 that rests on the surface 304 of the sidewalls 300 may include a stabilization feature, such as a groove, ridge, rib, etc., configured to interface with (e.g., engage) the surface 304 of the sidewalls 300 to inhibit (e.g., prevent) lateral movement (e.g., translation in the X-direction and/or Y-direction), while still enabling rotational movement (e.g., in the X-Y plane) about the sidewalls 300. For example, the stabilization feature may extend around at least part of the periphery of the base portion 252 and may be configured (e.g., sized, shaped, etc.) to rest on the surface 304 of the sidewalls 300. The stabilization feature may at least partially stabilize the airflow control device 250 during movement (e.g., rotational movement) of the airflow control device 250. The stabilization feature may stabilize the airflow control device 250 during movement (e.g., rotational movement) of the airflow control device 250.

The shape of the first end 294 of the pipe 292 (e.g., the shape of the sidewalls 300) may be complementary to the shape of the base portion 252 of the airflow control device 250 to effectively control (e.g., inhibit or restrict) the flow of air 306 that may be drawn through the pipe 292 during use. Thus, during use, the channels 262 may be the only paths that air outside of the system 290 can take to pass into the first end 294 of the pipe 292 and through the pipe 292 to the second end 296, where the air exits the pipe 292. Accordingly, the channels 262 may be configured to direct airflow from outside the first end 294 of the pipe 292, along the channels 262 and the base portion 252 of the airflow control device 250, and inside of the first end 294 of the pipe 292. In addition, the airflow control device 250 may increase the pressure and facilitate mixing of the air 306 within the first end 294 of the pipe 292 during use. The size and/or shape of the channels 262 may directly influence the pressure and/or mixing of the air 306 within the pipe 292, so the size and/or shape of the channels 262 of the airflow control device 250 may be tailored based on a desired functionality during use.

During use, a suction force may be created at the second end 296 of the pipe 292, which may draw the air 306 proximate the first end 294 of the pipe 292 into the pipe 292 via the channels 262. The air 306 may travel along the channels 262, which as shown in FIG. 19, may create a helical airflow pattern to facilitate mixing of the air 306 within the first end 294 of the pipe 292. The flow of the air 306 moving through the channels 262 may generate a force (e.g., a rotational force) acting on the base portion 252. The force may be sufficiently strong to rotate the base portion 252, which may further facilitate mixing of the air 306 and/or regulate temperature of the air 306.

The first end 294 of the pipe 292 may include a substance (e.g., a concentrate, such as a “dab”) at the base 298 of the first end 294 of the pipe within the central cavity 302. Accordingly, an exterior surface of the base 298 may be heated (e.g., via a flame, such as from a lighter) to vaporize and/or combust the substance, that may mix with the air 306 to form a substantially homogenous mixture (e.g., homogenous in composition, temperature, etc.) of the air 306 and vapor and/or smoke that then travels through the remainder of the pipe 292 and out of the second end 296 of the pipe 292.

In some embodiments, the first end 294 of the pipe 292 may additionally include one or more spherical element(s) (e.g., “terp ball(s)” or “terp pearl(s)”) that may rotate around the base 298 the first end 294 of the pipe 292 to further facilitate mixing of the air 306 and, optionally, another substance (e.g., a concentrate, such as a “dab”) that may be positioned at the base 298 of the first end 294. After the air 306 has been mixed to evenly distribute the temperature and, optionally, another substance throughout the air 306, the air 306 (e.g., the substantially homogenous air-substance mixture) may travel through the pipe 292 and exit through the second end 296.

What is claimed is:

1. An airflow control device, comprising:
a base portion defining an internal cavity, the base portion defining channels configured to direct airflow alongside the base portion; and
a cap portion configured to removably connect to the base portion to fully enclose the internal cavity.

2. The airflow control device of claim 1, wherein the center of gravity of the airflow control device is located within a lower half of the base portion.

3. The airflow control device of claim 1, wherein the channels comprise helical channels.

4. The airflow control device of claim 1, wherein a depth of the channels is within a range of from about 0.5 mm to about 3 mm.

5. The airflow control device of claim 1, wherein the internal cavity comprises:
a first internal cavity; and
a second internal cavity separated from the first internal cavity by a central member.

6. The airflow control device of claim 1, wherein a depth of the internal cavity is within a range of from about 15% to about 50% of a height of the base portion.

7. The airflow control device of claim 1, wherein maximum lateral dimensions of the internal cavity are within a range of from about 50% to about 95% of the maximum lateral dimensions of the base portion.

8. The airflow control device of claim 1, wherein the cap portion comprises a different material than the base portion.

9. The airflow control device of claim 1, wherein the internal cavity comprises a substantially cylindrical shape.

10. The airflow control device of claim 1, wherein the airflow control device further comprises an intermediate portion defining an additional internal cavity.

11. The airflow control device of claim 1, wherein the base portion comprises a connection feature configured to connect to the cap portion.

12. The airflow control device of claim 1, wherein the base portion comprises a polymer material and the cap portion comprises the polymer material.

13. An airflow control device, comprising:
a base portion defining a first internal cavity, the base portion defining channels configured to direct airflow alongside the base portion;
an intermediate portion defining a second internal cavity, the intermediate portion removably connected to the base portion; and
a cap portion removably connected to the intermediate portion.

14. The airflow control device of claim 13, wherein the base portion exhibits a substantially conical shape.

15. The airflow control device of claim 13, wherein the intermediate portion comprises:
a first intermediate portion defining the second internal cavity, the first intermediate portion removably connected to the base portion; and
a second intermediate portion defining a third internal cavity, the second intermediate portion removably connected to the first intermediate portion and fully enclosing the second internal cavity, the second intermediate portion further removably connected to the cap portion.

16. The airflow control device of claim 13, wherein the channels extend from sides of the base portion to proximate a center of the base portion.

17. The airflow control device of claim 16, wherein the channels individually exhibit triangular shapes with wide ends proximate sides of the base portion, and narrow ends proximate the center of the base portion.

18. The airflow control device of claim 13, wherein the base portion comprises a feature configured to interface with sidewalls of a pipe.

19. A method of manufacturing an airflow control device, the method comprising:
forming a base portion defining an internal cavity, and
forming a cap portion configured to removably connect to the base portion to fully enclose the internal cavity.

20. The method of claim 19, wherein:
forming a base portion comprises additively manufacturing the base portion; and
forming a cap portion comprises additively manufacturing the cap portion.
